(19) United States
(12) Patent Application Publication
(10) Pub. No.: US 2008/0147553 A1
(43) Pub. Date: Jun. 19, 2008

(54) Automated On-line Generation and Distribution of Advertisement and Promotional Materials

(75) Inventors: Aaron Richard Orner, Waxahachie, TX (US); Gary Alan Sproat, Carrollton, TX (US)

Correspondence Address: WOOD, HERRON & EVANS, LLP, 2700 CAREW TOWER, 441 VINE STREET, CINCINNATI, OH, 45202, US

(73) Assignee: INTERVERZ, LLC, Dallas, TX (US)

(21) Appl. No.: 11/950,191

(22) Filed: Dec. 4, 2007

Related U.S. Application Data
(60) Provisional application No. 60/868,466, filed on Dec. 4, 2006.

(51) Int. Cl. G06Q 30/00; H04L 9/00; G06F 7/00; G06F 17/30

(52) U.S. Cl. 705/50; 705/14; 707/104.1; 707/10; 707/E17.116

(57) ABSTRACT

Print advertising is distributed by generating an ad-template and importing the ad-template into an online library via an Internet connection. The ad-template is modified via the Internet connection and the ads are automatically delivered to publications from the online library via the Internet connection. A server manages the distribution of print advertising. The server includes an Internet connection interface, a printer server interface for receiving an ad-template by the delivery of information from a client via a printer protocol, and online library storage for storing an ad-template received by the printer server interface.

### FIELD OF THE INVENTION

The present invention relates to the distribution of advertisement and promotional materials.

### BACKGROUND OF THE INVENTION

Advertisement is a crucial part of the modern economy. Billions of dollars are spent annually on advertisements with the objectives of attracting consumer attention to one competitive good over another. The most sophisticated advertisement is generated by consulting firms and agencies, or at large corporations, internal marketing departments, taking advantage of economies of scale and distributing the advertisement content to a large number of retail markets spread over a wide area. Frequently advertisements are time sensitive as they feature regional or nationwide sales, seasonal information and information linked to major holidays or buying periods.

In the state of the art, corporate advertising departments and agencies distribute advertisement copy to local retail marks using a number of technologies. Generally, these technologies can be characterized as cumbersome, slow, and expensive.

For example, manual delivery of electronic files for generation of print ads may require distribution of large numbers of media (e.g., CD's) or extensive manual effort for online delivery of suitable copy.

Furthermore, national or regional content (e.g., illustrating products and sale prices applicable across the nation or region) frequently requires customization for local markets, e.g., to identify the hours or location of a local retailer in a retail chain, or to identify specific exemptions or conditions for a given retailer. This customization is often accomplished manually, at great expense and delay. The cost of such customizations often is prohibitive, as a result of which, the advertisements are not as targeted as would be desired. Additionally, local printers and publications often impose individualized requirements for advertisement copy that vary from one publisher or printer to another, representing an additional customization requirement.

In addition, the process for advertisement approval is frequently inefficient and fragmented. Documentation formats are often unstructured requiring manual or ad hoc methods for approval. Furthermore, the lack of an audit trail for approval often undermines the accountability in the process.

The consequences of slow, cumbersome processes in advertisement distribution are numerous, including compromise of a brand identity or image due to inconsistent or undesirable advertisement results, poor service to local stores or franchises in a chain, fragmented communication, excessive late change fees from printers and publications, and disproportionate management effort required in troubleshooting and problem solving advertisement distribution issues.

A number of services are available to advertisers that seek to streamline the delivery of advertisement content. Among these services are:

Saepio, which provides a software product that enables local marketers to use a standard web browser to create a desired version of a marketing piece such as a print ad, sales flyer, direct mailer and web-to-print document.

eMotion Ad Builder is a software product that enables corporate marketing departments and advertisement agencies to provide local marketers with branded marketing content such as print ads, flyers, and direct mailers that can be customized with local messages.

Pica9 is a software product that provides “production wizards” enabling account managers to produce camera-ready, localized advertising materials, by customizing product, price and location information within the context of a nationalized campaign.

BRANDflex is a software product that is used for desktop publishing corporate compliant, print-quality advertisements

AAS is a software product that is related to Saepio, and allows personalization of national marketing materials to account for local conditions.

BrandMuscle provides a software product for corporate ad version that automates logistics of advertising production, coordination and distribution.

While these various products are useful in organizing and streamline the process of generating and customizing advertisement materials, there is still opportunity to further increase the efficiency of the generation of advertisements and improve the intercommunication of executives and creative personnel involved in the generation of those materials.

### SUMMARY OF THE INVENTION

The present invention overcomes these difficulties with the prior art by providing a server and method of its operation which enables the online distribution of print advertising, by the generation of an ad-template, and importation of the ad-template into an online library via an Internet connection in its native format, where it may be modified and used to deliver ads automatically to publications. Importantly, the delivery to the online library, and the modification at the online library and the delivery of ads, all utilize an Internet connection. Thus, for example, a user of the server need only have a web browser for interfacing to the server.

In the particular disclosed embodiment, the server also allows on-line, web browser modification of the ad-template, by mapping data from database fields to customizable areas of the ad-template. Furthermore, a user may import, via an Internet connection, a database containing localization data to be used within the ad-template, such as a spreadsheet or delimited data file. This localization data may include specific information to be included in specific ads, and a manifest of ads to be generated, and publications to which those ads are to be delivered. This data is merged with the templates to generate the multiple ad versions.

In the disclosed embodiment, the initial delivery of the ad-template may be facilitated by a printer server interface for receiving the ad-template in the manner of delivery of a print job from a client via a printer protocol, over an Internet connection.

Furthermore, the server may implement a proof review process, in which proofs are generated from an ad template and localization data, and notifications are delivered to users designated to approve proofs, and those proofs are then reviewed via an Internet connection. The notifications are themselves delivered via an Internet connection. The server may also include a template manager, able to modify the ad-template in response to commands delivered to the template manager via an Internet connection. Further, the server may include a proof manager, displaying and modifying or annotating proofs of ads generated from an ad-template, in response to commands delivered to the proof manager via an Internet connection.

After approval of proofs, the ads are delivered automatically to publications by generating and delivering notices, via an Internet connection, to publications designated to receive the ads.

These various specific embodiments comprise separate aspects of the invention, as well as detailed features of other aspects of the invention.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a block diagram illustrating the process of creating the print material and advertisements consistent with embodiments of the invention.

FIG. 2 is a flow diagram illustrating the inputs and outputs of the different stages of the process in FIG. 1.

FIG. 3A is an exemplary representation of a print window from a commercial design program used to create a template for the process in FIG. 1.

FIG. 3B is an exemplary representation of a print status window from a commercial design program as the template is being created.

FIG. 4 is a representation of a web page used to configure the template uploaded in FIG. 3A.

FIG. 5 is a representation of a web page used to import manifest data consistent with the process in FIG. 1.

FIG. 6 is a representation of a web page used to create versions of the print material consistent with the process in FIG. 1.

FIG. 7 is a representation of a web page used to verify the versions of the print material consistent with the process in FIG. 1.

FIG. 8 is another representation of a web page used to verify the versions of the print material consistent with the process in FIG. 1.

FIG. 9 is a representation of a web page used to approve or disapprove of a version of the print material verified in FIGS. 7 and 8.

FIG. 10 is a representation of a web page used for delivery of the versions of the print material consistent with the process in FIG. 1.

### DETAILED DESCRIPTION

Embodiments of the invention provide an opportunity within the advertising industry to automate and streamline the cumbersome, costly process of localizing, personalizing, and distributing print advertising to franchises or company-owned locations. Through online services and the Internet, advertisers and their agencies gain the ability to automatically customize and distribute mass quantities of print advertising in a fraction of the time and cost of conventional methods. The online service may be used, for example, for a national placement (“flight”) of a series of ads or for a single ad revision (“one-off”) or minor customizations. The service utilizes templates generated by the client to produce the series of print advertising. All of the templates of the client's ads are stored in an on-line library. Template revisions may then be completed in mass by importing a comprehensive ad manifest, e.g. in the form of a spreadsheet, and/or by accessing each individual template.

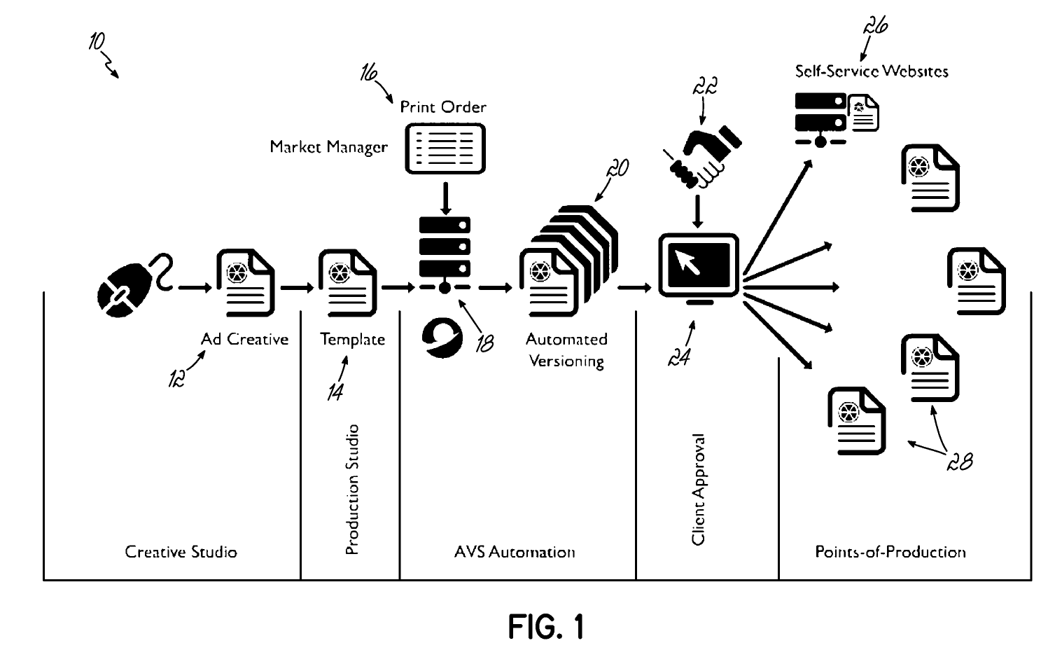

Referring now to an overview of an embodiment of the online service 10 accessible via the Internet and illustrated in FIG. 1, a client of the online service 10 locally creates a generic version of the print material/advertisement in a design program 12, such as QuarkXPress®, InDesign®, or any other widely used layout tools and programs. This generic advertisement is uploaded to the online service 10 as a template by printing to an Internet printer set up in the layout tool or program. Other embodiments may use other methods to upload templates, such as e-mail or ftp transfers. Once the templates are uploaded, the client of the online service 10 can use the template manager 14 to group content options (language, locality, or date) to create specific versions of the print material or advertisements. The template manager 14 may also set up user permissions for the templates or parts of the templates as well as manage fonts and images that are to be used in conjunction with the template.

Print orders or manifests 16 are input containing information defined by the client of the online service 10. The information in the manifest 16 is combined with the appropriate template in the data manager 18, which automatically generates proofs 20 of the advertisements for review. Clients or other approving entities 22 may access the proofs 20 through a proof manager 24. After the proofs have been reviewed and accepted, final documents may then be generated from the proofs 20 and delivered to the appropriate self service web site 26 or point-of-production 28.

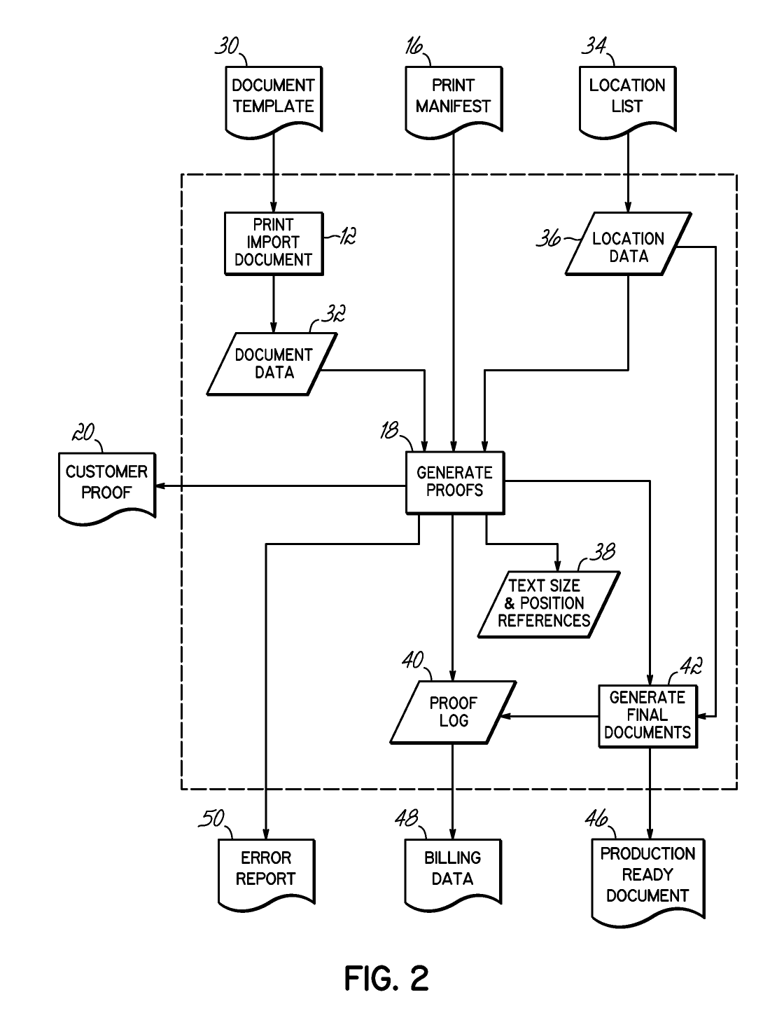

The data flow for the process utilized in the online service 10 may be seen in the block diagram of FIG. 2. As stated above in conjunction with FIG. 1, document templates 30 are created in a commercial layout tool or program 12 and the document data is uploaded to the online service 10 via an Internet printer or other uploading methodology. Print manifest data 16 is uploaded by the client to the online service 10 as well as a location list 34 containing localization data, such as geographic location, delivery type/format, preferred delivery means, etc., which may be stored with the templates as location data 36 that is used in preparation of the proofs 20. The data manager 18 combines the document data 32 (stored templates) with data from the manifest 16 and location data 36 in the case of location specific versions of the advertisements. Text size and position references 38 are also consulted and additionally stored so that they can be retrieved and reused. The data manager 18 then checks the imported data for any errors, and if none are found, generates a set of proofs 20. The proofs 20 are then reviewed by appropriate approving entities, which either approve or deny the use of each of the versions of the advertisements. This process is recorded in the proof log 40 by the data manager 18. Final documents 42 are generated from the approved proofs 20 and delivered in production ready form 46. Once the advertisements has been delivered, billing data 48 consisting of a list of versions of advertisements generated, approved and delivered is created which is in turn used to bill the client for the work completed. If the data manager 18 detects errors in the generation process, the data manager 18 writes the errors into an error report 50 which may be reviewed by the ordering client.

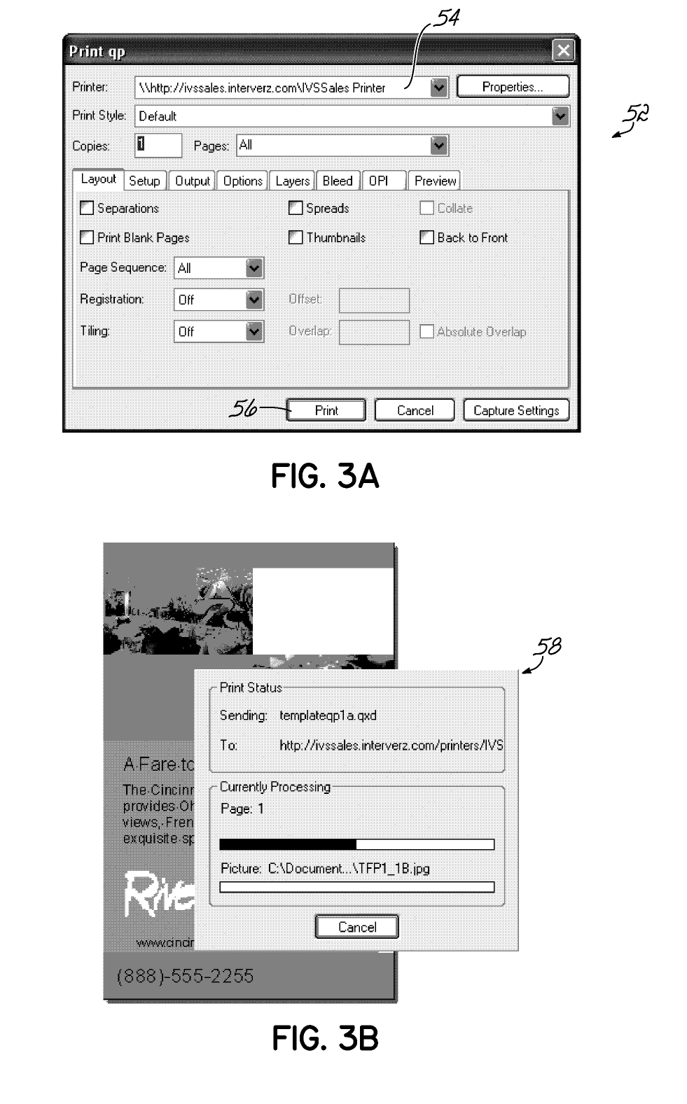

An Internet printer is set up on the local client's machine that is used to upload template files to the online service 10. This allows the template files to be uploaded in their native formats rather than in a proprietary format. FIG. 3A shows an exemplary print window 52 from a commercial layout package. The user of the package selects the Internet printer from the printer drop down menu 54. This printer is set such that when files are uploaded via this printer, they are stored in an on-line library of templates in a specific area accessible only to this client. In other words, the client is recognized based on the Internet printer during the upload. The upload process is initiated when the client hits the print button 56 in the print window. Progress of the upload may be monitored through a print status window 58 as shown in FIG. 3B. Once the template files are uploaded to the appropriate client areas, the templates are ready for versioning using the template manager 12 in the online service 10.

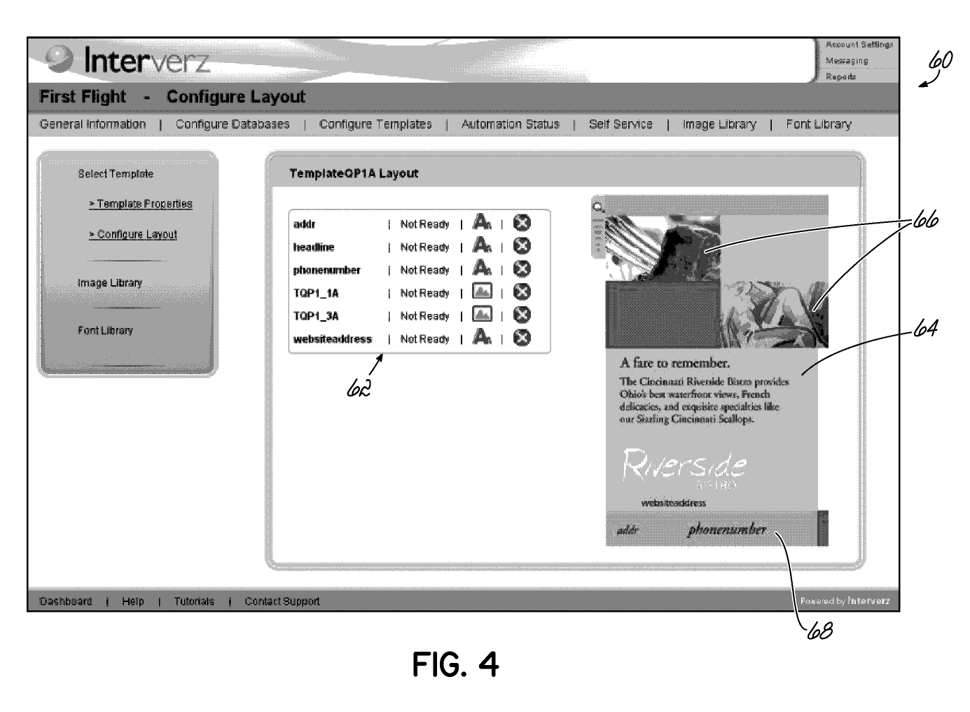

The client accesses the template manager 12 using a standard HTTP protocol through the web interface 60 shown in FIG. 4. Customizable areas of the ad-template are automatically mapped to date from the database files, such as the print manifest 16 and location data 36. Additionally, the web interface 60 allows the client to further customize the template for local or other markets. The client may select areas of the template and make the areas variable, such that the areas may be automatically changed when creating the different versions of the advertisements. For example, the client may assign attributes 62 to the variable elements, such as headlines 64, photos or images 66, addresses 68, among others. After defining the variable areas, fonts, and other template access information, the templates are ready to use to create versioned advertisements.

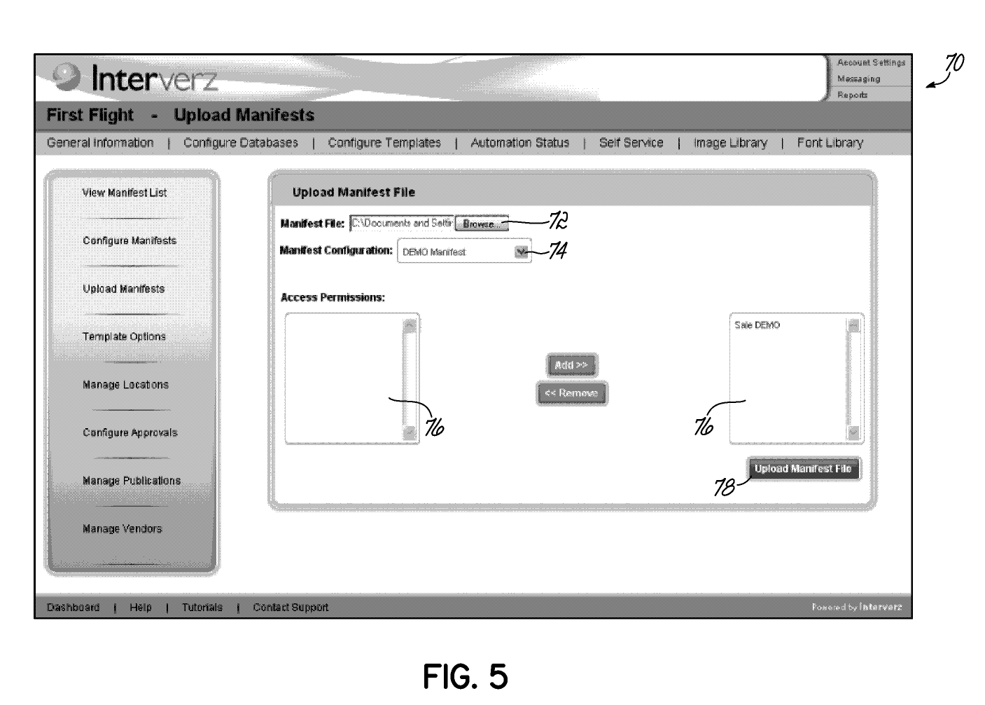

As illustrated in FIG. 5, a new print order may be initiated by uploading a print manifest file 16 using the web interface 70. A manifest file, or print order source, is, in some embodiments, a spreadsheet or other delimited file that provides the data manager 18 with versioning information. The data manager 18 the automatically creates the print versions from this spreadsheet. In order to upload a manifest file 16, the client selects the print order source by selecting the browse button 72 and selecting a manifest file 16. The online service 10 then enables multiple configuration and/or format options, which may be selected from the drop down menu 74. Access permissions may be added by selecting the permissions and adding them with the boxes 76. The manifest file 16 may then be uploaded by selecting the upload button 78. The manifest file 16 is uploaded and checked for errors, which are reported with the upload.

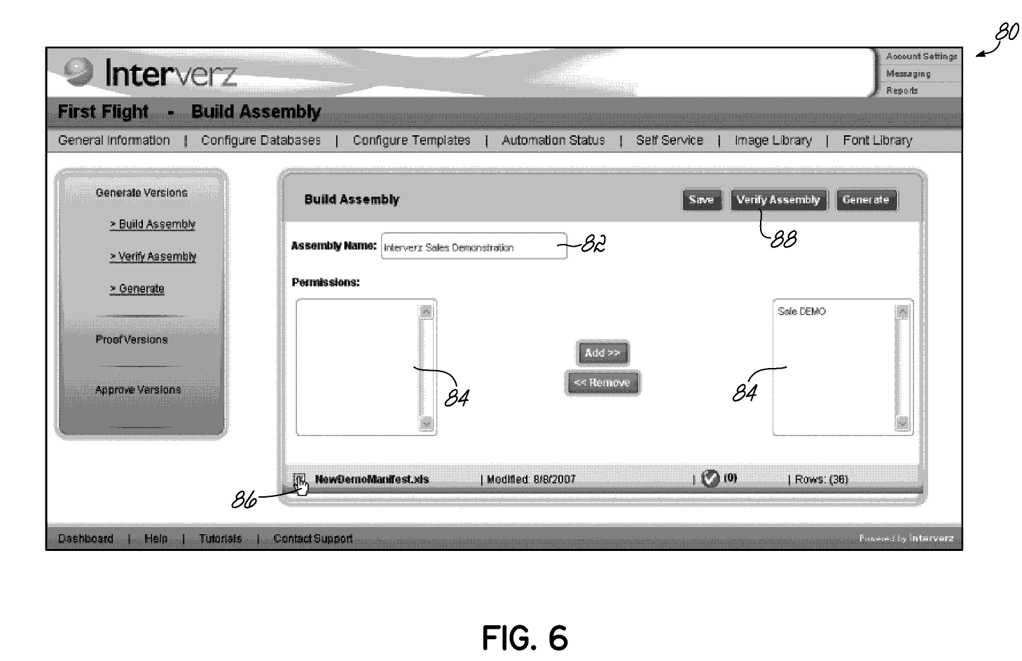

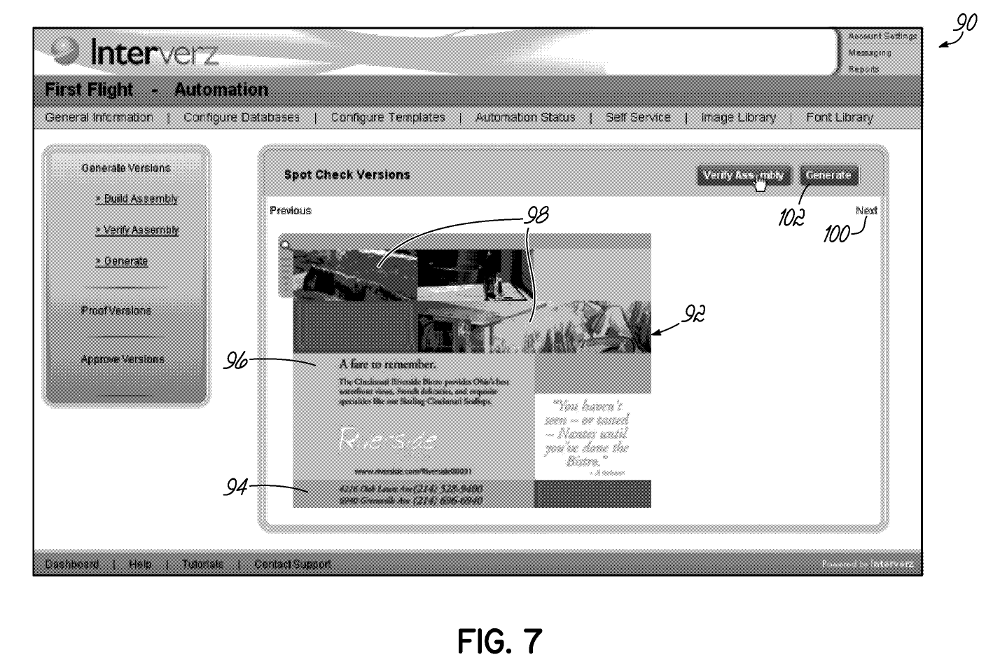

The data manager 18 is now able to create the ad versions from the newly uploaded print order. The client builds the versions using the web interface 80 shown in FIG. 6. First the assembly is named by typing in a name in block 82. Any permissions pertaining to this assembly are selected and added in the boxes 84. The print order that was uploaded is attached by selecting 86 the manifest file 16. This may also reference data from the location data 36 database previously uploaded. The manifest 16 and location data 36 are merged with the templates to create multiple versions of the advertisements. The versions may now be reviewed/spot checked for any initial errors. The client selects the view assembly button 88 to review the versions. The data manager 18 verifies that the assembly has no errors and then transfers the client to the web interface 90 to spot check the versions shown in FIG. 7. A representation of a version 92 of the advertisements is shown in the interface for visual inspection by the client. The client may check items that were variables in the template to ensure that the proper information was added. Information such as addresses 94, headings 96, photos 98, among others may be verified. After verification of the first version, the client may use the next button 100 to check the next version of the advertisements. After each of the versions have been verified, the client can generate proofs 20 of versions by selecting the generate button 102. The proofs 20 are then ready for the approval process. In some embodiments, the generator may report the number of errors, number of versions to generate, number of templates used, number of vendors, number of publications, etc.

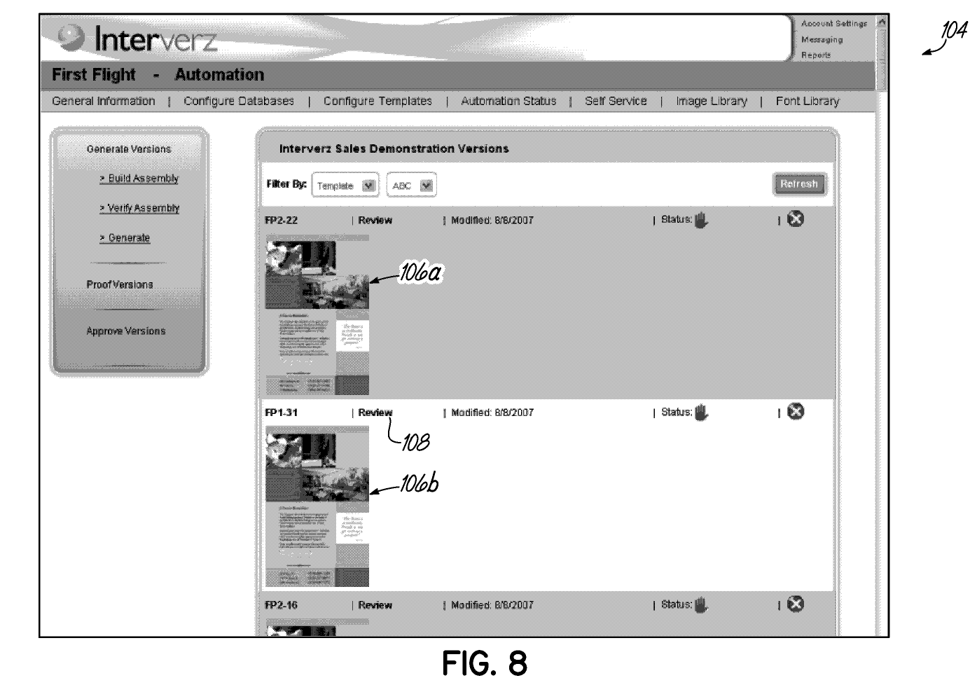

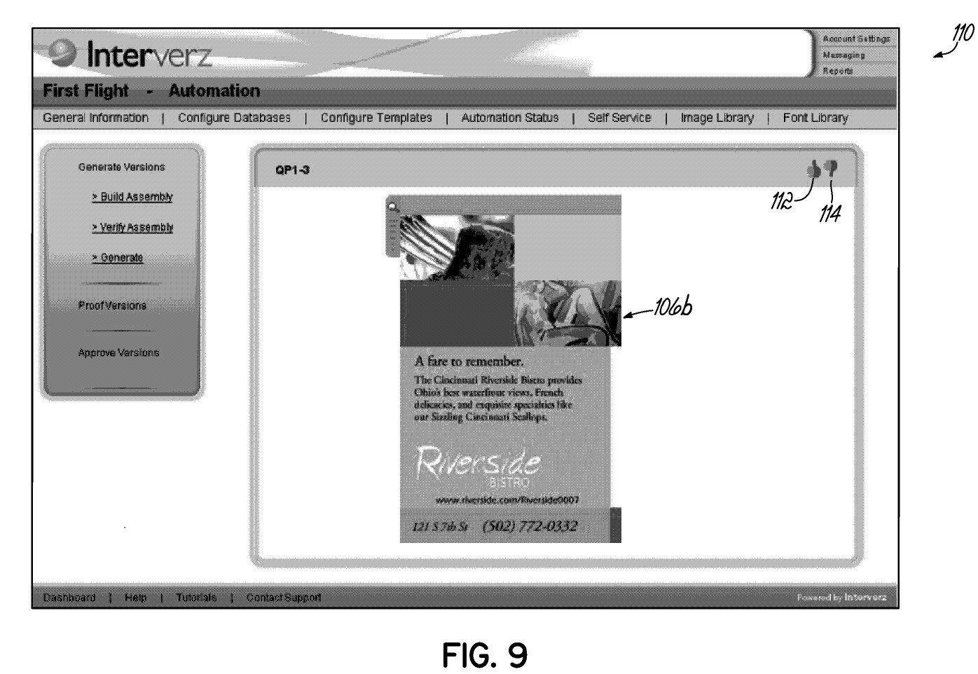

The online service 10 is adaptable to individual approval methods. In one embodiment, the approvers may approve versions via a simple on-line process based on permissions assigned by the client. In the on-line process, a list of assemblies awaiting version approval is presented with an error status and the number of versions in each assembly. The assembly is selected by the approver, which directs the approver to the proof manager 24 web interface 104 show in FIG. 8. The web interface 104, displays the different versions 106a, 106b, etc. and their current approval status. To review one of the versions, the approver selects the review hypertext 108 near the version that he or she wants to inspect. The selection displays the particular version in the web interface 110 show in FIG. 9. The version may then be accepted 112 or denied 114 by selecting the appropriate icon. Additionally in some embodiments, the approver may be allowed to make minor changes to each individual proof based on protections set by the client. The changes may include moving text, changing a font or font size, or selecting a different picture, for example.

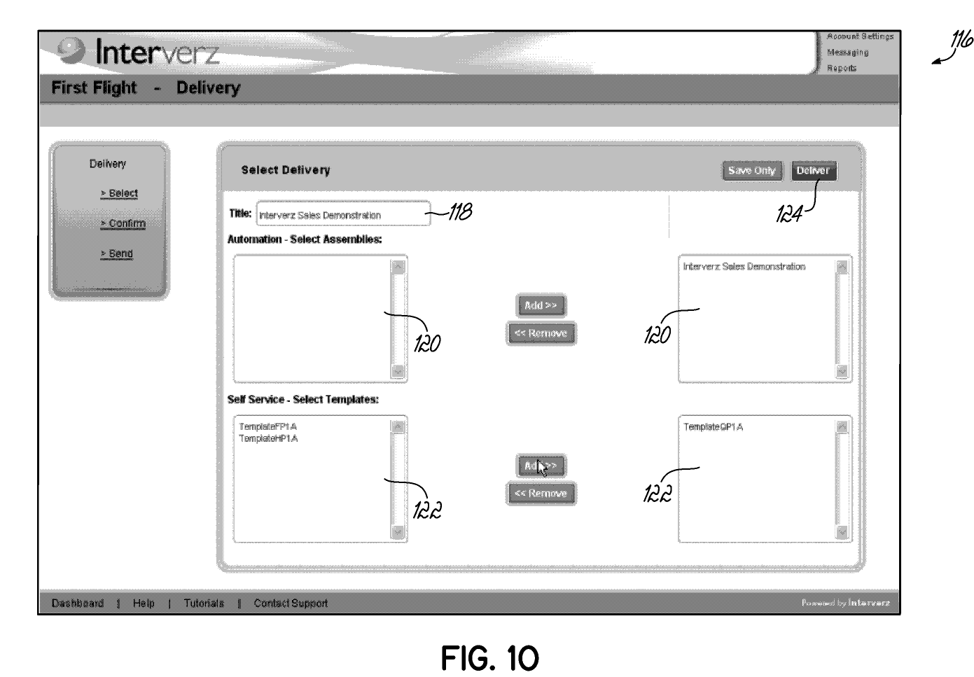

Once approved, the delivery manager 24 through its web interface 116, shown in FIG. 10, allows the client to select an assembly or assemblies for delivery. In one embodiment, the online service 10 will automatically deliver versions directly to the client's vendors, publications, and other points of production. To deliver the versions, first a delivery package is named by typing a name in the box 118. The version assembly package is then selected from the windows 120 and added to the delivery content. If a self service package is being created, a template is also selected for delivery in the windows 122. The delivery is confirmed by selecting the delivery button 124. In some embodiments, a report is produced indicating the number of versions in the delivery package, any self service templates, and any error status. The client may then indicate that they have the authorization or the authority to deliver the deliverables and then hits a send button. The delivery package is then queued for automatic delivery, which may be via e-mail or ftp delivery for some embodiments using electronic delivery. Additionally, in some embodiments, a delivery notice may be sent to the approvers and/or to publications designated to receive the ads indicating that there has been a delivery of the approved ads. In other embodiments, the client may deliver a portion of the versions of the printed material or only those that have been approved, skipping over those versions of ads that have not been approved. Forms of the electronic delivery may include PDF format, EPS format, etc. The format selection may be determined from the manifest data, distribution area, etc.

Some embodiments of the delivery manager may also run status reports to determine if all of the proofs have been approved. These reports may automatically generate overviews and summaries of recent flights. Reports may be run by flight, user, or client. As data is merged with the templates to create versions, the actual placement and size of the merged data is stored so that it can be compared with any restrictions added to the template. This allows the data manager 18 to automatically report any potential errors caused by data overflowing its allowed space. In some embodiments, the size and placement data is written to a text file during the processing of the final Postscript file. Run error reports may use this output data to determine if any proofs are flagged as “Need Attention” by the system. The delivery manager 18 may determine that a proof needs attention based on layout issues that are related to content size, resolution, and margin settings. For example, if the text is outside an area, the proof is flagged as “Need Attention.” The approver approving the version may remove the flag after reviewing the version. The client may also receive revision requests sent by approvers during the review process.

As described above, both versioned ads and templates may be delivered. Delivering templates along with versioned ads allows local markets to receive ready-to-go campaigns or customize their marketing materials on an ad-hoc basis. The customizable materials may be versioned directly by the end user based on the delivered template and in accordance with the protections and limitations set for those templates. For example, the template may allow the end user to move text or to change graphics between images from an approved set to better customize the advertisement for their target audience.

Communications with the online service 10 utilize security measures to protect the intellectual property uploaded and managed on the server hosting the online service 10. Encrypted communications are used utilizing accepted standards such as 128 bit SSL to assist in preventing the interception of the client's data between the client's location and the secure server. Additional server-side encryption may also be employed for additional security, which encrypts data at the time it is received in the server and decrypts the data only for transmission to the client's browser.

While all of the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the applicant's general inventive concept.

What is claimed is:

1. A method of distributing print advertising, comprising:
generating an ad-template;
importing the ad-template into an online library via an Internet connection;
modifying of the ad-template via an Internet connection; and
delivering the ads automatically to publications from the online library via an Internet connection.

2. The method of claim 1 wherein the step of modifying the ad-template comprises:
automatically mapping data from database fields to customizable areas of the ad-template via an Internet connection.

3. The method of claim 2 further comprises:
storing a position and a size of the data mapped from the database fields to the customizable areas of the ad-template.

4. The method of claim 2 wherein the step of modifying the ad-template further comprises:
importing via an Internet connection a database containing localization data to be used within the ad-template.

5. The method of claim 4 wherein the localization data comprises a spreadsheet or delimited data file.

6. The method of claim 4 wherein the localization data comprises an ad manifest.

7. The method of claim 6 wherein the ad manifest identifies advertisement placements for advertisements generated with the ad-template and localization data.

8. The method of claim 1 wherein said Internet connections are encrypted connections using a Secure Socket Layer.

9. The method of claim 1 wherein said Internet connection utilizes hypertext transfer protocol (http).

10. The method of claim 1 wherein the modifying of the ad-template is performed via an Internet connection using web browser software.

11. The method of claim 1 further comprising:
reviewing proofs of ads to be generated using the ad-template, via an Internet connection.

12. The method of claim 11 further comprising:
receiving revision requests responsive to review of proofs, via an Internet connection.

13. The method of claim 11 further comprising:
generating and delivering notices of the availability of proofs, via an Internet connection, to users designated to approve said proofs.

14. The method of claim 1 wherein delivering ads automatically to publications comprises:
generating and delivering notices, via an Internet connection, to publications designated to receive the ads.

15. The method of claim 1 wherein the ad-template is imported into the online library in its native format.

16. A server for managing the distribution of print advertising, comprising:
an Internet connection interface;
a printer server interface for receiving an ad-template by the delivery of information from a client via a printer protocol;
online library storage for storing an ad-template received by the printer server interface.

17. The server of claim 16 further comprising:
a template manager, the template manager modifying the ad-template in response to commands delivered to the template manager via an Internet connection using a hypertext transfer protocol (http).

18. The server of claim 16 further comprising:
a data manager, the data manager receiving, via an Internet connection, and storing data sources for customizing individual ads to be generated from an ad-template.

19. The server of claim 18 wherein said data manager further generates ad proofs from data from the data source and an ad-template.

20. The server of claim 16 further comprising:
a proof manager, the proof manager displaying and modifying or annotating proofs of ads generated from an ad-template, in response to commands delivered to the proof manager via an Internet connection using a hypertext transfer protocol (http).

21. The server of claim 18 further comprising:
a delivery manager, the delivery manager generating ads from an ad-template and data sources, and delivering resulting ads to publications based upon delivery information in data sources.

22. The server of claim 21 wherein the delivery manager delivers ads via an Internet connection.
